(19) United States
(12) Patent Application Publication
(10) Pub. No.: US 2010/0045810 A1
(43) Pub. Date: Feb. 25, 2010

(54) Video Signal Processing System and Method Thereof

(76) Inventors: Huang Chun-Ru, His Chih City (TW); Chiang Hsu, His Chih City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/265,764

(22) Filed: Nov. 6, 2008

(30) Foreign Application Priority Data
Aug. 20, 2008 (TW) 097131773

(51) Int. Cl. H04N 5/228; H04N 7/12; H04N 5/225

(52) U.S. Cl. 348/222.1; 375/240.01; 348/262; 375/E07.076; 348/E05.024; 348/E05.031

(57) ABSTRACT

An video signal processing method and system thereof are disclosed. The system comprises four cameras for capturing four video signals (1373×986 pixels, frame rate is 22.5 fps). Each video signal may be adjusted and encoded in the camera to form an output video signal (960×540 pixels, frame rate is 19.98 fps). Each frame (960×540 pixels) of the output video signal may be segmented into three fields (720×240 pixels) to be the output video of the camera. Each camera transmits the processed output video (three fields, each field is 720×240 pixels, frame rate is 19.98 fps) to a digital video recorder via a coaxial cable. The digital video recorder may decode and restore the processed output video signal to the output video signal (960×540 pixels). Then the digital video recorder may transmit the several output video signal to a display device, and the several output video signal may be displayed into the display device in quad screen format to form a high definition video corresponding to the output video standard (1080p).

### BACKGROUND OF THE INVENTION

1. Field of the Invention

The present invention relates to an video signal processing method and system thereof; more particularly, relates to an video signal processing method and system thereof which utilize cameras with analog transmission interface to transmit a plurality of video signal (format is 960×540 pixels), and utilize a digital video recorder to decode and transmit the video signals to a display for displaying high-definition video (format is 1920×1080 pixels) effects in a split display mode.

2. Description of the Related Art

Mostly, a conventional camera (such as a CCTV camera) utilizes an analog transmission interface. For example, a conventional camera utilizes a coaxial cable to transmit video signal for being displayed on a television or a display. Under such kind of analog transmission interface, video transmission bandwidth, video resolution and video transmission rate is limited to the transmission medium (such as a coaxial cable), whose maximum bandwidth is 6 MHz, video resolution is 720×480i, and video transmission rate is 29.97/30 fps.

With the development of television technology, it seems that digital televisions are going to gradually replace traditional analog televisions. A digital television can display high-definition video, as well as transmit video via a digital transmission interface (such as a HDMI cable). Therefore, the digital television can display high-Definition video, (such as 1080p or 1080i); its transmission rate is 60 fps. With the popularity of high-definition televisions, users have relatively higher expectations towards video signal captured by cameras. However, cameras with analog transmission interfaces can not transmit high-definition video due to bandwidth limitations. Therefore, in order to display high-definition video on the display, manufacturers not only have to use lenses with higher resolution, but also need to completely utilize digital transmission interface (such as HDMI transmission interface) in place of analog transmission interface (such as coaxial cable), so as to have enough bandwidth to transmit high-definition video for being displayed on the display.

Because cameras with analog transmission interface are quite popular nowadays, if there is a need of displaying high-definition video (such as 1080p or 1080i with transmission rate at 60 fs), all cameras with analog transmission interface have to be replaced by cameras with digital transmission interface, and all cameras have to change lenses with higher resolution. With regard to users who have already purchased such analog monitoring systems, it would cost a lot to replace the system structure. Therefore, there is a need for displaying high-definition video output effects on digital televisions without completely replacing camera lenses and cameras with analog transmission interface.

Therefore, there is a need to provide a video signal processing system and method thereof to mitigate and/or obviate the aforementioned problems.

### SUMMARY OF THE INVENTION

A main objective of the present invention is to provide a video signal processing method capable of using cameras with analog transmission interface to transmit video to a digital television for displaying high-definition video (available high definition video format, 1080p standard). The method of the present invention comprises the following steps: (a) obtaining a plurality of video signal; (b) adjusting parameters of the video signal for obtaining a plurality of output video signal; (c) encoding and segmenting the output video signal, such that a frame of the output video signal is segmented into a plurality of fields; (d) transmitting the plurality of fields of the output video signal via a plurality of coaxial cables; (e) decoding and restoring the plurality of fields of the output video signal; and (f outputting the plurality of output video signal in a split display mode.

A video signal processing system of the present invention comprises a plurality of cameras, a digital video recorder (DVR) and a display device. The plurality of cameras is used for obtaining a plurality of video signal. Each camera comprises a charge-coupled device (CCD), a signal processing unit and an encoder. Each Video sensed by the CCD are transmitted to the signal processing unit for adjusting video resolution, so as to form a plurality of output video signal. The encoder performs a video segmentation and encoding process to frames of each output video signal, so as to obtain a plurality of fields. The digital video recorder is connected to the plurality of cameras via a plurality of coaxial cables. Each coaxial cable is used for transmitting the plurality of fields outputted by each camera. The digital video recorder receives and decodes the plurality of fields, so as to restore the plurality of fields into the plurality of output video signal for being displayed in a split display mode. The display device is connected to the digital video recorder, and is used for receiving and displaying the plurality of output video signal outputted by the digital video recorder.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a schematic drawing of a video signal processing system of the present invention.

FIG. 2 is a flowchart of a video signal processing method of the present invention.

FIG. 3 is a schematic drawing showing a video output signal process of the video signal processing method of the present invention.

### DETAILED DESCRIPTION OF THE PREFERRED EMBODIMENT

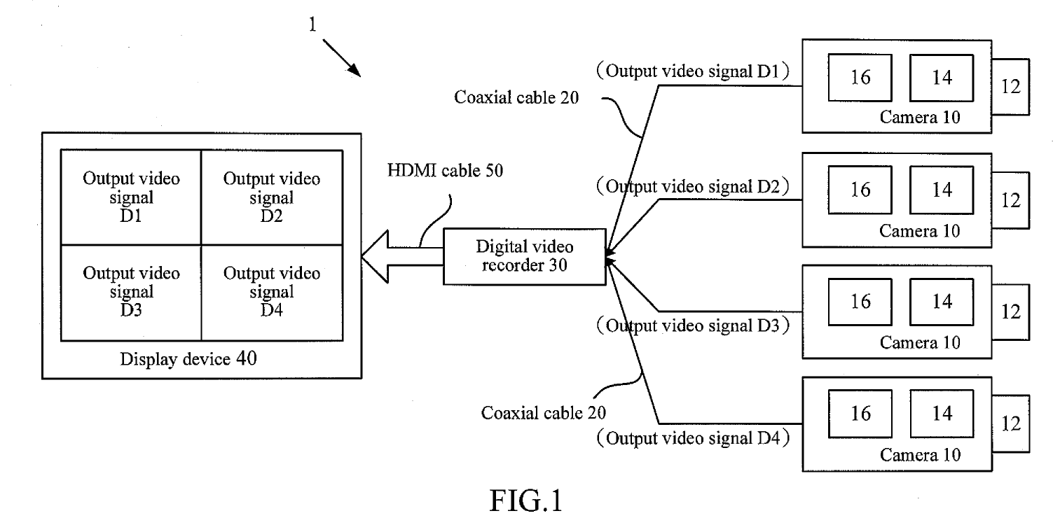

Please refer to FIG. 1, which is a schematic drawing of a video signal processing system of the present invention. The video signal processing system 1 of the present invention is applied in a national television system committee (NTSC) system. As shown in FIG. 1, the video signal processing system 1 comprises a plurality of (i.e. four) cameras 10, a plurality of (i.e. four) coaxial cables 20, a digital video recorder 30, a high definition multimedia interface (HDMI) cable 50, and a display device 40. Each camera 10 is used for capturing a video signal and transmitting the video signal to the digital video recorder 30 (DVR). The digital video recorder 30 is connected to each camera 10 via each coaxial cable 20. The digital video recorder 30 can receive and store the plurality of video signal outputted by the plurality of cameras 10. The digital video recorder 30 is connected to the display device 40 via the HDMI cable 50. The digital video recorder 30 has a split display mode; therefore, the digital video recorder 30 can integrate the plurality of video signal from multiple resources (i.e. four cameras 10), such that video captured by the four cameras 10 can be displayed in quad screen format on the display device 40.

In this embodiment, when four video signal (each format is 920×1000 pixels) are displayed simultaneously, a video displayed on the display device 40 (totally format is 1920×1080 pixels).

In this embodiment, each camera 10 comprises a charge-coupled device (CCD) 12, a signal processing unit 14 and an encoder 16. The CCD 12 can obtain a plurality of video signal (format is 1373×986 pixels, transmission rate is 22.5 fps). The signal processing unit 14 is used for processing video signal sensed by the CCD 12, and transmitting the video signal to the encoder 16 for performing an encoding process. After the encoding process, four output video signals D1, D2, D3 and D4 are formed. A resolution of each output video signal format is 960×540 pixels, and a transmission rate of each output video signal is 59.94/60 fs. The output video signals D1, D2, D3 and D4 are simultaneously displayed in quad screen format on the display device 40, so as to form a 1080p (high-definition video, format is 1920×1080 pixels).

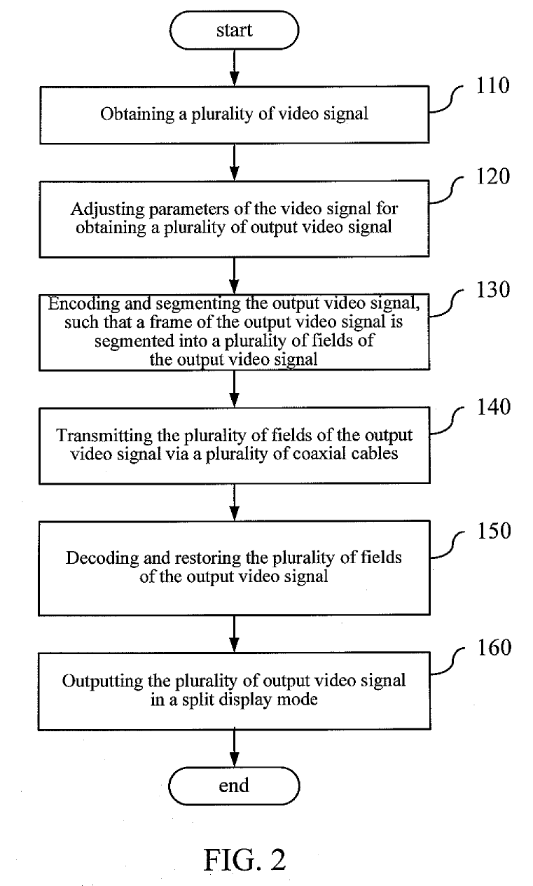

Please refer to FIG. 2, which is a flowchart of a video signal processing method of the present invention. Although the video signal processing system 1 shown in FIG. 1 is used as one preferred embodiment for explaining the video signal processing method of the present invention, please note that the video signal processing method of the present invention can be applied in any other similar video signal processing systems without being limited to the video signal processing system 1. As shown in FIG. 2, the video signal processing method of one preferred embodiment of the present invention comprises steps 110˜160. Each step would be described in detail hereinafter.

At first, the video signal processing method performs step 110: obtaining a plurality of video signal. As shown in FIG. 1, in the preferred embodiment of the present invention, each camera 10 comprises a CCD 12, a signal processing 14 and an encoder 16. Four cameras 10 respectively capture four video signals via each CCD 12. The standard of each captured video signal may vary according to different CCD 12 used by each camera 10. In this embodiment, a resolution of the CCD 12 used by each camera 10 is 1373×986 pixels, a transmission bandwidth of each video signal bandwidths outputted by each camera 10 is 36 MHz, and a transmission rate of each video signal is 22.5 fps.

After step 110, the video signal processing method then performs step 120: adjusting parameters of each video signal for obtaining a plurality of output video signals D1, D2, D3 and D4.

As shown in FIG. 1, in order to meet a 1080p high-definition video output effect, the signal processing unit 14 of the camera 10 utilizes an all-pixels scan methodology to capture video signal. In this embodiment, the parameters of the video signal comprise a video resolution, a transmission bandwidth and a video transmission rate of the captured video signal. For the four video signal captured in step 110, this embodiment adjusts their resolution from 1373×986 pixels to 960×540 pixels, lowers their bandwidth from 36 MHz to 32 MHz, and adjusts their transmission rate from 22.5 fps to 19.98/20 fps. Therefore, after the cameras 10 perform such internal adjustment, for each output video signal finally outputted by the cameras 10, the resolution is 960×540 pixels, the transmission bandwidth is 32 MHz, and the transmission rate is 19.98/20 fps.

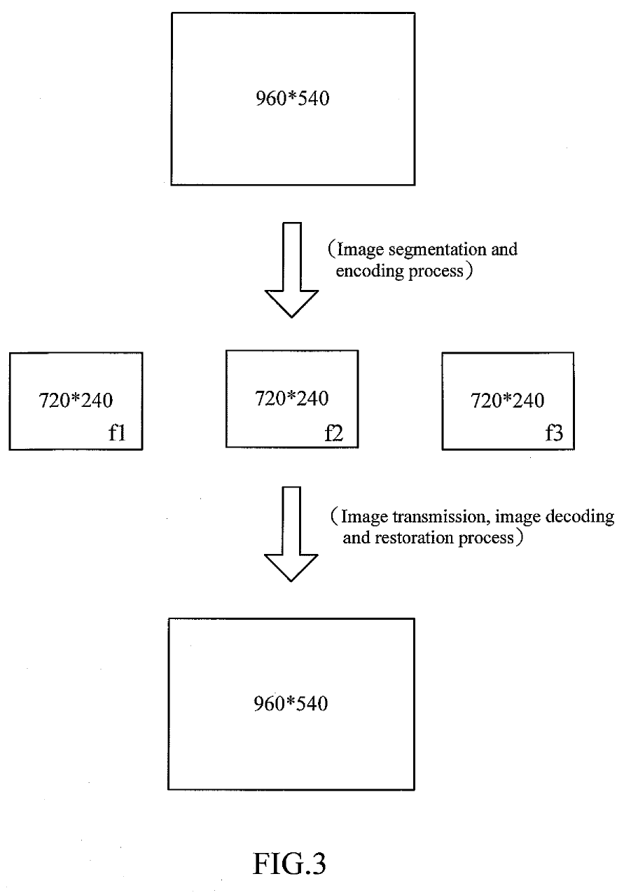

After step 120, the video signal processing method then performs step 130: encoding and segmenting the output video signal, such that a frame of the output video signal is segmented into a plurality of fields of the output video signal (for example, frame format of the video signal is 960×540 pixels, filed format of the video signal is 720×240 pixels). Please refer to both FIG. 1 and FIG. 3. FIG. 3 is a schematic drawing showing a video output signal process of the video signal processing method of the present invention. As shown in FIG. 1 and FIG. 3, after step 120 obtains the plurality of output video signals D1, D2, D3 and D4, the video signal processing method utilizes the encoder 16 to perform the video segmentation and encoding process to each output video signal in order to transmit the video via the coaxial cable. The encoder 16 of each camera 10 is a vertical blanking interval (VBI) encoding circuit, which performs the encoding process to each frame F of each output video signal, so as to segment and encode each frame (960×540-pixels) of each output video signal into three fields (720×240-pixels). In this embodiment, each frame of each output video signal is segmented and encoded into three fields, wherein each field format is 720×240 pixels. However, please note that the sizes of the frames and fields are not limited to the above description. Furthermore, the video signal processing method utilizes the signal processing unit 14 to assign numbers to the plurality of fields (f1, f2 and f3) formed after the video segmentation process, so as to facilitate succeeding processes.

After step 130, the video signal processing method then performs step 140: transmitting the plurality of fields via a plurality of coaxial cables. As shown in FIG. 1, in the preferred embodiment of the present invention, the video signal processing system 1 comprises a plurality of (i.e. four) coaxial cables 20, wherein each coaxial cable 20 corresponds to each camera 10. Because each output video signal has been segmented and encoded into a plurality of fields in step 130, the plurality of fields formed from each output video signal can be transmitted via each coaxial cable 20 corresponding to each camera 10.

After step 140, the video signal processing method then performs step 150: decoding the plurality of fields (720×240 pixels), and restoring the plurality of fields into the plurality of output video signal (960×540 pixels). As shown in FIG. 1 and FIG. 3, the video signal processing system 1 comprises a digital video recorder 30, wherein the digital video recorder 30 is connected to the four cameras 10 via the four coaxial cables 20. After said video signal processing, three fields (each filed format is 720×240 pixels) formed from each frame of each output video signal can be transmitted to the digital video recorder 30 via each coaxial cable 20. The digital video recorder 30 has a corresponding VBI decoding circuit (not shown in figures). Therefore, the digital video recorder 30 can restore the three fields (720×240 pixels) formed from each output video signal into the original frame (960×540 pixels) of each output video signal. Accordingly, the digital video recorder 30 can form four output video signals D1, D2, D3 and D4.

In the NTSC system, standards of video transmission rates such as 23.98/24 fps, 25 fps, 29.97/30 fps and 59.94/60 fps can meet the 1080p video quality. In this embodiment, a selected transmission rate is 59.94/60 fps. Therefore, the preferred transmission rate of 59.94/60 fps can be achieved after tripling each output video with its original transmission rate at 19.98/20 fps. However, please note that the preferred transmission rate and the original transmission rate are not limited to the above description. As a result, for each transformed output video signal, its format is 960×540 pixels, and its transmission rate is 59.94/60 fps. The video signal processing method can sequentially perform a video restoration process to the plurality of fields formed from each output video according to the numbers f1, f2 and f3 assigned in step 130. Furthermore, the digital video recorder 30 can be any kind of video signal processing apparatus equipped with a digital video recording function without being limited to this embodiment.

Finally, the video signal processing method performs step 160: outputting the plurality of output video signal in a split display mode. As shown in FIG. 1, in the preferred embodiment of the present invention, the video signal processing system 1 comprises a display device 40. The display device 40 is connected to the digital video recorder 30. The digital video recorder 30 is used for receiving and outputting the output video signals (960×540 pixels) D1, D2, D3 and D4 outputted from the four cameras 10. The four output video signals D1, D2, D3 and D4 are displayed in quad screen format on the display device 40 via the digital video recorder 30 to form a 1920×1080-pixels video. In this embodiment, the display device 40 can be a high definition television (HDTV), wherein the HDTV is connected to the digital video recorder 30 via a HDMI cable. Because the resolution of each output video signal format is 960×540 pixels and the transmission rate of each output video signal is 59.94/60 fps, the display device 40 can display a complete high-definition video with its resolution is 1920×1080 pixels and transmission rate at 59.94/60 fps. Therefore, a 1080p standard video output effect can be achieved.

The video signal processing method and system thereof of the present invention can utilize video (960×540 pixels) transmitted by a television with an analog transmission interface (coaxial cable), and directly transmit four video signals to the display device 40 for displaying in quad screen format via the digital video recorder 30. The present invention can display a 1080p high-definition video output effect by means of displaying high-definition video signal (with its format is 1920×1080 pixels and transmission rate at 59.94/60 fps). Therefore, the present invention can display high-definition video (1080p) on a display (such as a HDTV) without the need of replacing an original coaxial cable terminal with a HDMI terminal, so as to save cost.

Although the present invention has been explained in relation to its preferred embodiments, it is to be understood that many other possible modifications and variations can be made without departing from the spirit and scope of the invention as hereinafter claimed.

What is claimed is:

1. A video signal processing method, comprising the following steps:
(a) obtaining a plurality of video signal;
(b) adjusting parameters of the video signal for obtaining a plurality of output video signal;
(c) encoding and segmenting the output video signal, such that a frame of the output video signal is segmented into a plurality of fields of the output video signal;
(d) transmitting the plurality of fields of the output video signal via a plurality of coaxial cables;
(e) decoding and restoring the plurality of fields of the output video signal; and
(f) outputting the plurality of output video signal in a split display mode.

2. The method as claimed in claim 1, wherein the plurality of video signal are captured via a plurality of cameras, where a definition of each video signal is 1373×986 pixels, a transmission bandwidth of each video signal is 36 MHz, and a transmission rate of each video signal is 22.5 fps.

3. The method as claimed in claim 2, wherein each camera comprises a charge-coupled device (CCD), a signal processing unit and an encoder, and step (b) utilizes each camera to adjust the definition, the bandwidth and the transmission rate of each video signal and then performs an output process.

4. The method as claimed in claim 1, wherein a definition of each output video signal is 960×540 pixels, a transmission bandwidth of each output video signal is 32 MHz, and a transmission rate of each output video signal is 19.98/20 fps.

5. The method as claimed in claim 4, wherein step (c) performs the encoding process to each output video signal, segments the 960×540-pixels frame of each output video signal into three 720×240-pixels fields, and assigns numbers to each field.

6. The method as claimed in claim 5, wherein step (e) utilizes a digital video recorder to receive and decode the plurality of fields of the output video signal, so as to restore the 720×240-pixels fields into the 960×540-pixels frame for being outputted, wherein the transmission rate of each output video signal is 59.94/60 fs.

7. The method as claimed in claim 6, wherein the digital video recorder outputs the four output video signal into a display device in quad screen format for displaying a 1920×1080-pixels high-definition video.

8. A video signal processing system, comprising:
a plurality of cameras for capturing a plurality of video signal, each camera comprising a charge-coupled device (CCD), a signal processing unit and an encoder, wherein video signal sensed by the CCD are transmitted to the signal processing unit for adjusting definitions of the video signal so as to form a plurality of output video signal, and the encoder performs an video signal segmentation process and encoding process to frames of each output video signal so as to segment a plurality of fields;
a digital video recorder connected to the plurality of cameras via a plurality of coaxial cables, each coaxial cable used for transmitting the plurality of fields outputted by each camera, the digital video recorder used for receiving and decoding the plurality of fields so as to restore the plurality of fields into the plurality of output video signal for being displayed in a split display mode; and
a display device connected to the digital video recorder, used for receiving and displaying the plurality of output video signal outputted by the digital video recorder.

9. The video signal processing system as claimed in claim 8, wherein a definition of each video signal is 1373×986 pixels, a transmission bandwidth of each video signal is 36 MHz, and a transmission rate of each video signal is 22.5 fs.

10. The video signal processing system as claimed in claim 8, wherein a definition of each output video signal is 960×540 pixels, a transmission bandwidth of each output video signal is 32 MHz, and a transmission rate of each output video signal is 19.98/20 fps.

11. The video signal processing system as claimed in claim 10, wherein each camera performs the encoding process to each output video signal, segments a 960×540-pixels frame of each output video signal into three 720×240-pixels fields, and assigns numbers to the fields.

12. The video signal processing system as claimed in claim 11, wherein the digital video recorder receives the plurality of fields formed from each output video signal, and decodes the plurality of fields, so as to restore the 720×240-pixels fields into the 960×540-pixels frame for being outputted, wherein a transmission rate of each output video signal frame rate is 59.94/60 fps.

13. The video signal processing system as claimed in claim 12, wherein the digital video recorder outputs the four output video signal, format is 960×540-pixels into the display device in quad screen format for displaying a high-definition video, format is 1920*1080 pixels.

14. The video signal processing system as claimed in claim 8, wherein the display device is a high definition television (HDTV).
